(19) United States
(12) Patent Application Publication
(10) Pub. No.: US 2015/0208032 A1
(43) Pub. Date: Jul. 23, 2015

(54) Content data capture, display and manipulation system

(71) Applicant: James Albert Gavney, JR., San Mateo, CA (US)

(72) Inventor: James Albert Gavney, JR., San Mateo, CA (US)

(21) Appl. No.: 14/544,995

(22) Filed: Mar. 16, 2015

Related U.S. Application Data
(63) Continuation-in-part of application No. 13/999,935, filed on Apr. 4, 2014.
(60) Provisional application No. 61/995,987, filed on Apr. 28, 2014.
(60) Provisional application No. 61/999,500, filed on Jul. 29, 2014.
(60) Provisional application No. 61/964,900, filed on Jan. 17, 2014.
(60) Provisional application No. 61/965,508, filed on Feb. 3, 2014.
(60) Provisional application No. 61/966,027, filed on Feb. 14, 2014.

(51) Int. Cl. H04N 7/15; H04N 5/232; H04N 7/14

(52) U.S. Cl. CPC H04N 7/15; H04N 7/148; H04N 5/232; G06T 2207/10016; G06T 2207/30244; H04N 2007/145

(57) ABSTRACT

A system for manipulating content data such as video, word documents, graphics, spread sheets and data bases is disclosed. The system includes a networked viewing device that displays representations of the content data that pushed from or originating from a applications running on a networked computing device, such as a smart phone. This viewing device includes a touch screen or a periphery tool, such as keyboard and/or a computer mouse which is synchronized to the computing device for manipulating the content data while viewing a representation of the content data on the viewing device. In further embodiments of the invention the a periphery tool is the computing device, whereby a control application is running on the computing device to manipulate the content data originating from invisible application or program running on the computing device while the content data is displayed on the networked viewing device. The viewing device, the computing device and/or the system preferably includes a video capturing unit.

### RELATED APPLICATION(S)

This application is a continuation in part application of co-pending U.S. patent application Ser. No. 13/999,935, filed on Apr. 4, 2014, and titled “AUTOMATED DYNAMIC VIDEO CAPTURING”, which claims priority under 35 U.S.C. 119 (e) of the U.S. Provisional Patent Application Ser. No. 61/964,900 filed Jan. 17, 2014, and titled “SYSTEM FOR COLLECTING LIVE STREAM VIDEO DATA”, the U.S. Provisional Patent Application Ser. No. 61/965,508 filed Feb. 3, 2014, and titled “AUTOMATED DYNAMIC VIDEO CAPTURING”, and the U.S. Provisional Patent Application Ser. No. 61/966,027, filed Feb. 14, 2014, and titled “SYSTEM FOR COLLECTING LIVE STREAM VIDEO DATA OR RECORDING VIDEO DATA”.

This Application claims priority under 35 U.S.C. 119 (e) of the U.S. Provisional Patent Application Ser. No. 61/995,987 filed Apr. 28, 2014, and titled “AUTOMATED DYNAMIC VIDEO CAPTURING”, the U.S. Provisional Patent Application Ser. No. 61/999,500, filed Jul. 29, 2014, and titled “AUTOMATED DYNAMIC VIDEO CAPTURING”, and the U.S. Provisional Patent Application Ser. No. 62/124,145, filed Dec. 10, 2014, and titled “CONTENT DATA DISPLAY AND CREATION WITH SMART SCREENS”.

The U.S. patent application Ser. No. 13/999,935, filed on Apr. 4, 2014, the U.S. Provisional Patent Applications Ser. Nos. 61/964,900, filed Jan. 17, 2014, 61/965,508, filed Feb. 3, 2014, 61/966,027, filed Feb. 14, 2014, 61/995,987 filed Apr. 28, 2014, 61/999,500, filed Jul. 29, 2014, and 62/124,145, filed Dec. 10, 2014 are all hereby incorporated by reference.

### FIELD OF THE INVENTION

This invention relates content data capture display and manipulation. More particularly, the present invention relates video capturing devices, display devices and computing devices that are networked.

### BACKGROUND OF THE INVENTION

Digital communications has become common place due to speed and convince that digital data and information can be transmitted between local and remote devices. Current digital communications systems, however, provide an impersonal and static interactive experience.

On one end of the communication spectrum is “texting” that includes text messaging and e-mailing. Texting and emailing are impersonal and void of expression but do provide a quick and easy ways to convey information. On the other end of the communication spectrum are “meetings” or face-to-face communications that provide the most personal and expressive communication experience. However, meetings are not always convenient and in some cases are impossible. With the increased band width and transmission speed of networks (internet, intranet and local area networks) video communication has been increasingly filling the void between texting or e-mails and meetings.

For example, there are now several services that provide live-stream videos through personal computers or cell phones. Internet accessible video files that are posted (stored) on remote servers have become a common place method for distributing information to large audiences. These video systems do allow for a greater amount of information to be disseminated and do allow for a more personal and interactive experience. However, these video systems still do not provide a dynamic video experience.

It is estimated that the number of active cell phones will reach over 8 billion, a number greater than world-wide population. For may people these cell phones will be smart phones, which have as much computing power as most personal computers of years past. In many cases these smart phones will constitute the most powerful computing device that people own. Smart phones, while powerful computing devices, are not very good at performing a number of tasks currently performed using lap-top computers, desk-top computers, tablet computers, televisions and related networking systems.

### SUMMARY OF THE INVENTION

Prior art video system include surveillance video systems with static or pivoting video cameras operated remotely using a controller to document and record subjects or targets, such as in the case with drone surveillance systems. Action video system, including hand-held cameras, head mounted cameras and/or other portable devices with video capabilities, are used by an operator to document and record subjects or targets. Also, most desk-top computer systems are now equipped with a video camera or include the capability to attach a video camera. Some of the video systems that are currently available requires the operator follow or track subjects or targets by physically moving a video capturing device or by moving a video capturing device with a remote control. Other video systems require that the subject or target is placed in a fixed or static location in front of a viewing field of the video capturing device.

For the purpose of this application, the terms below are ascribed the following meaning:

1) Mirroring means that a two or more video screens are showing or displaying substantially the same graphical representation of content data, usually originating from the same source.

2) Pushing is a process of transferring content data from one device to a video screen of another device.

3) Streaming means to display a representation of content data on a video screen from a video capturing device in real-time as the content data is being captured within the limits of data transfer speeds for a given system.

4) Recording means to temporarily or permanently store content data from a video capturing device on a memory device.

5) Virtual projecting is displaying content data from originating from an application or program running from a computing device to a screen of networked viewing device and manipulating the content data from the networked viewing device via a touch screen or a periphery tool, such as keyboard and/or a computer mouse which is synchronized to the computing device.

6) Ghosting is running a control program on a computing device for manipulating content data originating from invisible application or program running on the computing device while displaying the content data on a networked viewing.

Embodiments of the present invention is directed a video system that automatically follows or tracks a subject or target once the subject or target has been selected with a hands-off video capturing device. The system of the present invention seeks to expand the video experience by providing dynamic self-video capability. In the system of the present invention video data that is captured with a video capturing device is shared between remote users, live-streamed to or between remote users, pushed from a video capturing device to one or more remote or local video screens or televisions, mirrored from a video capturing device to one or more remote or local video screens or televisions, recorded or stored on a local memory device or remote server or any combination thereof

The system of the present invention includes a robotic pod for coupling to video capturing device, such a web-camera, a smart phone or any device with video capturing capabilities. The robotic pods and the video capturing devices are collectively referred to, herein, as a video robots or video units. The robotic pod includes a servo-motor or any other suitable drive mechanism for automatically moving the coupled video capturing device to collect video data corresponding to dynamic or changing locations of a subject, object or person (hereafter, target) as the target moves through a space, such as a room. In other words, the system automatically changes the viewing field of the video capturing device by physically moving the video capturing device, or portion thereof, (lens) to new positions in order to capture video data of the target as the target moves through the space.

In some embodiments of the invention a base portion of the robotic pod remains substantially stationary and the drive mechanism moves or rotates the video device and/or its corresponding lens. In other embodiments of the invention the robotic pod is also configured to move or rotate. Regardless of how the video capturing device moves, the video device or its corresponding lens follows a target.

In accordance with an embodiment of the invention, the video capturing device or the robotic pod has image recognition capabilities. A camera from the video capturing device or a camera on the robotic pod is coupled to a microprocessor that runs software that allows the video robot to lock onto a target using color, shape, size or pattered recognition. Once the target is selected by, for example, taking a picture the video robot will follow and collect video data of the selected target. In other embodiments of the invention the video robot is equipped with sensor technology to identify or locating a selected target, such a described below.

In accordance with the embodiment of the invention the system includes sensor technology for sensing locations of the target within a space and then causes or instructs the video capturing device to collect video data corresponding the locations of the target within that space. Preferably, the system is capable of following the target, such that the target is within viewing field of the video capturing device with an error of 30 degree or less of the center of the viewing field of the video capturing device.

In accordance with the embodiments of the invention, the sensor technology (one or more sensors, one or more micro-processors and corresponding software) lock onto and/or identifies target being videoed and automatically tracks the video capturing device to follow the motions or movements of the target with the viewing field of the video capturing device as the target moves through the space. For example, the robotic pod includes a receiving sensor and the target is equipped with, carries or wears a device with a transmitting sensor. The transmitting sensor can be any sensor in a smart phone, in a clip on device, in a smart watch, in a remote control device, in a heads-up display (i.e Google Glasses) or in a Blue-Tooth head set, to name a few. The transmitting sensor or sensors and the receiving sensor or sensors are radio sensors, short-wavelength microwave device (Blue-Tooth) sensors, infrared sensors, acoustic sensor (respond to voice commands), optical sensor, radio frequency identification device (RFIDs) sensors or any other suitable sensors or combination of sensors that allow the system to track the target and move or adjust the field of view of the video capturing device, for example, via the robotic pod, to collect dynamic video data as target moves through space.

The sensor technology in hosted in the robotic pod, the video capturing device, an external sensing unit and/or combinations thereof. Preferably, the video capturing device includes a video screen for displaying the video data being collected by the video capturing device and/or other video data transmitted, for example, over the interne. In addition the system is configured to transmit and display (push and/or mirror) the video data being collected to a peripheral screen, such as a flat screen TV monitor or computer monitor using, for example, a wireless transmitter and receiver (Wi-Fi). The system of the present invention is particularly well suited for automated capturing of short range, within 50 meters, video of a target within a mobile viewing field of the video capturing device. The system is capable of being adapted to collect dynamic video data from any suitable video capturing device including, but not limited to, a video camera, a smart phone, web camera and a head mounted camera.

In further embodiments of the invention, a video capturing device includes the capability to push and/or mirror video data to one or more selected video screens or televisions through one or more wireless receivers.

In yet further embodiments of the invention a robot includes location data, mapping capabilities and/or collision avoidance detections. In operation, the video robot can be deployed, called or instructed to go to stored locations in doors or outs doors using a remote computer or remote control decide. The video robot can also be equipped with self-mapping software. In operation, the video robot roams a site or building and using collision avoidance software creates and stores a mapping data of and store locations within the site or building. The mapping data is then used deploy, call or instruct the video robot to automatically go to stored locations using a remote computer, a remote control or by inputting a location key, designation or address manually into the video robot through a user interface, such as a keyboard or keypad.

In still further embodiments of the invention, the robotic pod is a drone or unmanned flying device that couples to a video capturing device. The drone or unmanned flying device detects locations of a target and follows the target as the target moves through a space. In this embodiment, the sensor technology can include global positioning sensors that communicate locations of the target wearing the global position sensor to the drone or unmanned flying device.

The system of the present invention is also used for manipulating content data such as word documents, graphics, spread sheets and data bases. In accordance with this embodiment, a smart screen, smart monitor, display or a televison (viewing device) is used mirroring and displaying a representation of the content data pushed or originating from a computing device, such as a smart phone, over a network. This viewing device includes a touch screen or a periphery tool, such as keyboard and/or a computer mouse which is synchronized to the computing device for manipulating the content data while viewing a representation of the content data on the viewing device. In other word, the system virtual projects and displays content data originating from an application or program running on the computing device to a screen of a networked viewing device. In further embodiments of the invention the a periphery tool is the computing device, whereby a control application is running on the computing device to manipulate content data originating from invisible application or program running on the computing device (ghosting) all while being displayed on a networked viewing device or smart monitor.

### DESCRIPTION OF DRAWINGS

FIG. 1 shows a video system with a video robot, in accordance with the embodiments of the invention.

FIG. 2A shows a video system with a video robot that tracks a target, in accordance with the embodiments of the invention.

FIG. 2B shows a video system with multiple mobile location sensors or targets that are capable of being activate and deactivated to control a field of view of a video robot, in accordance with the embodiments of the invention.

FIG. 2C shows a video system with a drone and a tracking sensor that tracks a target or person wearing a transmitting sensor, in accordance with the embodiments of the invention.

FIG. 3 shows a video system with a video robot and a video and/or audio headset, in accordance with the embodiments of the invention.

FIG. 4 shows a video capturing unit with multiple video cameras, in accordance with the embodiments of the invention.

FIG. 5 shows a sensor unit with an array of sensors for projecting, generating or sensing a target within a two-dimensional or three-dimensional sensing field or sensing grid, in accordance with the embodiments of the invention.

FIG. 6 shows a representation of a large area sensor with sensing quadrants, in accordance with the embodiments of the invention.

FIG. 7 shows a representation of a video system with a multiple video units, in accordance with the embodiments of the invention.

FIG. 8A shows a video system with a video display device or a televison with a camera and a sensor for tracking a target, capturing video data of the target and displaying a representation of the video data, in accordance with the embodiments of the invention.

FIG. 8B shows a smart video screen or display device or a televison for mirroring and displaying a representation of the video data pushed from smart device over a network, in accordance with the embodiments of the invention.

FIG. 8C shows a smart video screen or display device or a televison for mirroring and displaying a representation of the content data pushed from smart device over a network and a periphery tool for manipulating the content data, in accordance with the embodiments of the invention.

FIG. 9 shows a video system with a video robot, a head mounted camera and a display, in accordance with the embodiments of the invention.

FIG. 10A shows a representation of a video system that includes a video capturing device that pushes video data to one or more selected video screens or televisions through one or more wireless receivers, in accordance with the embodiments of the invention.

FIG. 10B shows a representation of a video system that includes a video capturing device with a motion sensor and auto-video or auto-picture software, in accordance with the embodiments of the invention.

FIG. 11 shows a block flow diagram of the step for capturing and displaying video data corresponding to dynamic or changing locations of a target as the target moves through a space, in accordance with the method of the invention.

### DETAILED DESCRIPTION OF THE INVENTION

The video system 100 of the present invention includes a video capturing device 101 that is coupled to a robotic pod 103 (video robot 102) through, for example, a cradle. In accordance with the embodiments of the invention, the robot pod 103 is configured to power and/or charge the video capturing device 101 through a battery 109 and/or a power chord 107. The robotic pod 103 includes a servo-motor or stepper motor 119 for rotating or moving the video capturing unit 101, or portion thereof, in a circular motion represented by the arrow 131 and/or move in any direction as indicated by the arrows 133, such that the viewing field of the video capturing device 101 follows a target 113′ as the target 113′ moves through the space. The robotic pod 103 includes wheels 139 and 139′ that move the robot pod 103 and the video capturing device 101 along a surface or the servo-motor or stepper motor 119 moves the video capturing device 101 while the robotic pod 103 remains stationary.

The robotic pod 103 includes a receiving sensor 113 for communicating with a target 113′ and a micro-processor with memory 117 programmed with software configured to instruct the servo-motor or stepper motor 119 to move the video capturing device 101, and/or portion thereof, to track and follow locations of the target 113′ being videoed. The video capturing device 101 includes, for example, a smart phone with a screen 125 for displaying video data being captured by the video capturing device 101. The video capturing device 101 includes at least one camera 121 and can also include additional sensors 123 and/or software for instructing the server motor or stepper motor 113 where to position and re-position the video capturing device 101, such that the target 113′ remains in a field of view of the video capturing device 101 as the target 113′ moves through the space.

In accordance with the embodiments of the invention the target 113′ includes a transmitting sensor that sends positioning or location signals 115 to the receiving sensor 113 and updates the micro-processor 117 of the current location of the target 113′ being videoed by the video capturing device 101. The target 113′ can also include a remote control for controlling the video capturing device 101 to change a position and/or size of the field of view (zoom in and zoom out) of the video capturing device 101.

In accordance with an embodiment of the invention, the video capturing device 101 or the robotic pod 103 has image recognition capabilities. In accordance with the embodiments of the invention the camera 121 from the video capturing device 101 is coupled to the micro-processor with memory 117 programmed with software configured that allows the video robot 102 to lock onto detected locations of the target 113′ using color, shape, size or pattered recognition. The target 113′ can be selected by, for example, taking a picture of the target 113′ with the camera 121, which is then analyzed b the micro-processor. Based on the detected locations of the target 113′ the micro-processor 117 instructs the servo-motor or stepper motor 119 to move the video capturing device 101, and/or portion thereof, to track and follow locations of the target 113′ being videoed. In further embodiments of the invention, the receiving sensor 113 is a camera or area detector, such as described with reference to FIG. 6. As described above, the receiving sensor 113 on the robotic pod 103 is coupled to the micro-processor with memory 117 programmed with software configured to allow the robotic pod 103 to lock onto detected locations of the target 113′ using color, shape, size or pattered recognition. Based on the detected locations of the target 113′ the micro-processor 117 instructs the servo-motor or stepper motor 119 to move the robotic pod 103, to track and follow locations of the target 113′ being videoed by the attached or coupled video capturing device 101. In other embodiments of the invention the video robot is equipped with sensor technology to identify or locating a selected target, such a described below.

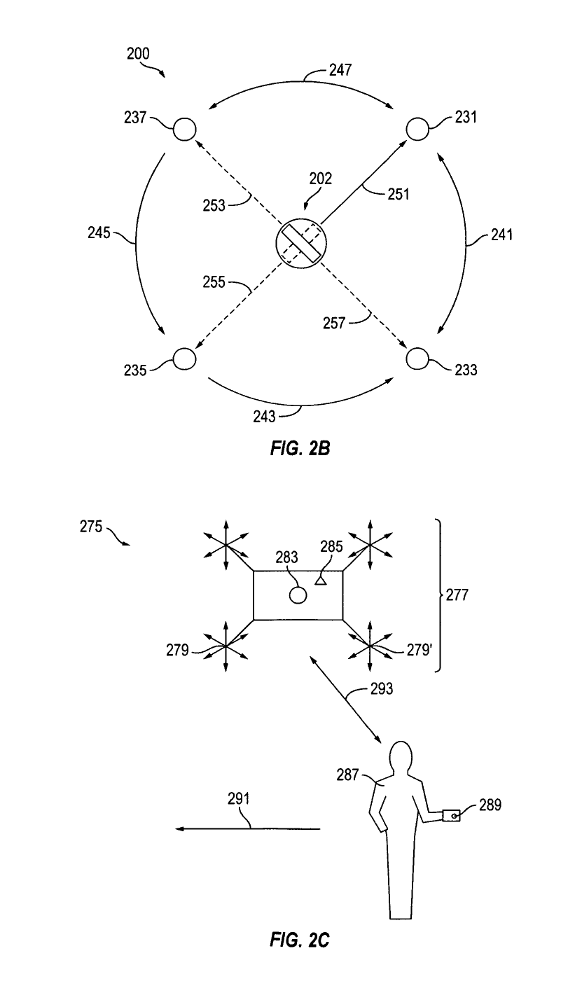

Referring to FIG. 2A, in operation the target 113′ is, for example, a sensor pin or remote control, as described above, that is attached to, worn on and/or held by a person 141. As the person 141 moves around in a space, as indicated by the arrows 131′ and the arrows 133′ and 133″, the video robot 102, or portion thereof, follows the target 131′ and captures dynamic video data of the person 141 as the person moves through the space. Preferably, the video robot 102, or portion thereof, is capable of following target 131′ and capture dynamic video data of the person 141 as the person moves through 360 degrees of space, as indicated by the arrows 131′. The video data is live-streamed from the video capturing device 101 to a periphery display device and/or is recorded and stored in the memory of the video capturing device 101 or any other device that is receiving the video data. The video robot 102 sits, for example, on a table 201 or any other suitable surface and moves in any number of directions 131′ 133′ and 133″, such as described above, on a surface of the table 201.

In further embodiments of the invention the video system 100 can include multiple targets and/or include multiple mobile transmitting sensors (mobile location sensors) that are turned on and off, or are otherwise controlled, to allow the video robot 102 to switch back and forth between targets or focus on selected portions of targets, such as described below.

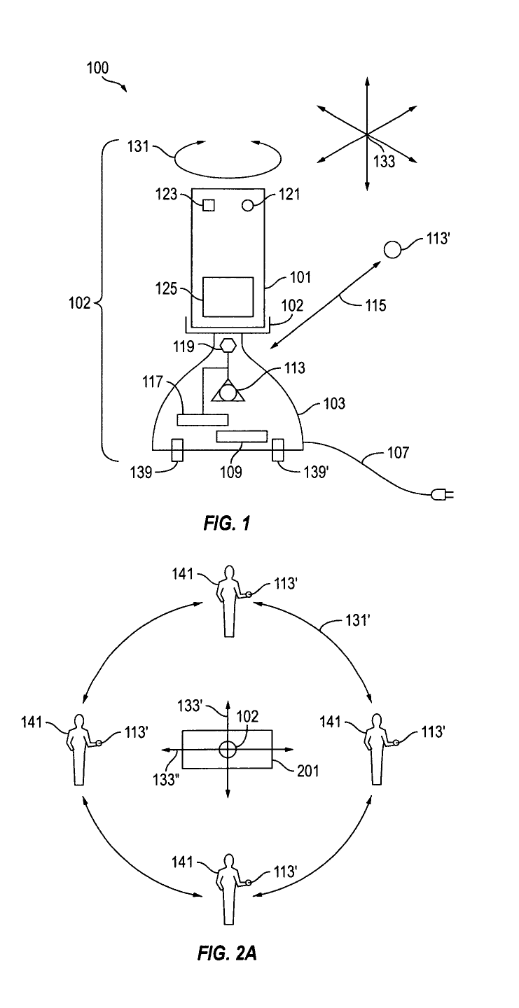

FIG. 2B shows a video system 200 with multiple mobile location sensors or targets 231, 233, 235 and 237 that are capable of being activate and deactivated to control a field of view of a video capturing unit, represented by the arrows 251, 253, 255 and 257 on a video robot 202, similar to the video robot 102 described with reference to FIG. 1. By selectively activating and deactivating the mobile location sensors 231, 233, 235 and 237, the video robot 202 will rotate, move or reposition, as indicated by the arrows 241, 243, 245 and 247 to have the activated mobile location sensors in the field of view of the video robot 202. The mobile location sensors 231, 233, 235 and 237 can be equipped with controls to move the video robot 202 to a preferred distance, focus and/or zoom the field of view of a camera positioned on the video robot 202 in and out.

FIG. 2C shows a video system 275 with a drone 277 and a tracking sensor 285 that tracks a target or person 287 wearing a transmitting sensor 289, in accordance with the embodiments of the invention. The drone (or unmanned flying device) 277 couples to a video capturing device 283 and detects locations of a target 287 and follows the target 287 as the target moves through a space, as indicated by the arrow 291. In this embodiment, the sensor technology 285 and 289 can include global positioning sensors that communicate locations of the target 287 wearing the global position sensor 289 to the drone 277. The drone 277 and the tracking sensor 285 can be programed to maintain a selected distance from the target 287, as indicated by the arrow 293, while capturing dynamic video of the target 287 with the video capturing device 283.

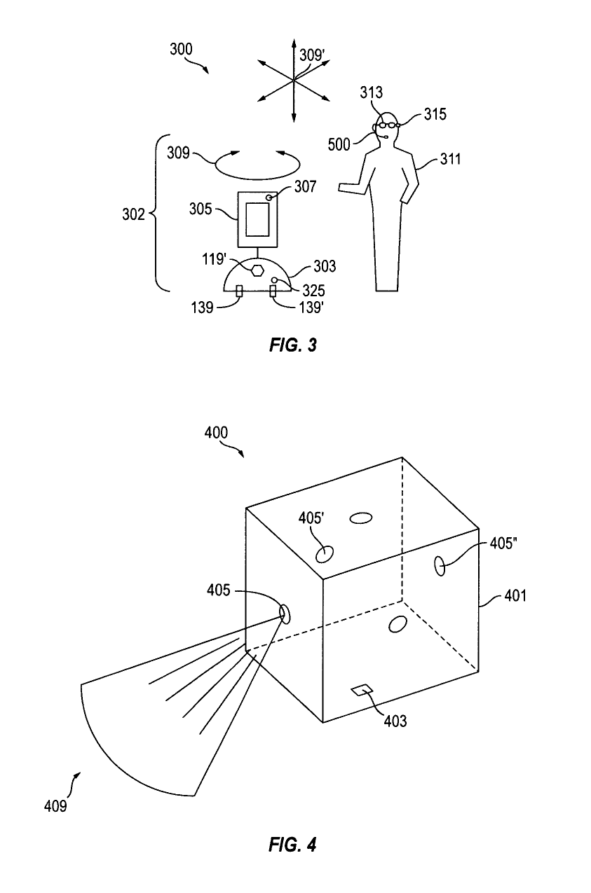

Referring now to FIG. 3, a video system 300 of the present invention includes a video robot 302 with a robotic pod 303 and a video capturing device 305, such as described with reference to FIG. 1. The pod 303 includes a sensor 325 (transmitting and/or receiving), a mechanism 119′ to move the video capturing device 305 with a camera 307 (or portion thereof), a micro-processor with memory, a power source and any other necessary electrical connections (not shown). The mechanism 119′ to move the video capturing device 305 with the camera 307, includes a servo-motor or stepper motor that engages wheels 139 and 139′ or gears to move the video capturing unit 301, the video capturing device 305 or any portion thereof, such as described above. In operation, the robotic pod 301 moves the video capturing device 305, or portion thereof, in any number of directions represented by the arrows 309 and 309′, in order to keep a moving target within a field of view of the camera 307.

Still referring to FIG. 3, a described above, a person or subject 311 wears or carries one or more transmitting sensor devices (transmitting and/or receiving) that communicates location signals to one or more sensors 325 on the robotic pod 303 and/or video capturing device 305 and the micro-processor instructs the mechanism 119′ to move the video capturing device 305, lens of the camera 307 or any suitable portion of the video capturing device 305 to follow the person or subject 311 and keep the person or subject 311 in a field of view of the video capturing device 305, as the person or subject 311 moves through a space. The one or more transmitting sensor devices includes, for example, an Blue-Tooth head-set 500 with ear-phone and a mouth speaker and/or a heads-up display 315 attached to a set of eye glasses 313. Where the one or more transmitting sensor devices include a heads-up display 315, the 311 person is capable of viewing video data received by and/or captured by the video capturing device 305 even when person's back facing the video capturing device 305.

In operation multiple user's are capable of video conferencing while moving and each user is capable of seeing other users even with their backs facing their respective video capturing devices. Also, because the head-sets 500 and/or heads-up displays 315 transmits sound directly to an ear of a user and receives voice data through a micro-phone near the mouth of the user, the audio portion of the video data streamed, transmitted, received or recorded remains substantially constant as multiple users move around during the video conferencing.

Now referring to FIG. 4, in yet further embodiments of the invention the video system 400 includes a video capturing unit 401 that has any number or geometric shapes. The video capturing unit 401 includes multiple video cameras 405, 405′ and 405″. The video capturing unit 401 includes a sensor (transmitting and/or receiving), a micro-processor, a power source any other necessary electrical connections, represented by the box 403. Each of the video cameras 405, 405′ and 405″ has a field of view 409. In operation the video capturing unit 400 tracks were target is in a space around the video capturing unit 401 using the sensor and turns on, controls or selects the appropriate video camera from the multiple video cameras 405, 405′ and 405″ to keep streaming, transmitting, receiving or recording video data of the target as the target through a space around the video capturing unit 401. The video capturing unit 401 moves, such as described with reference to the video robot 102 (FIG. 1), or remains stationary.

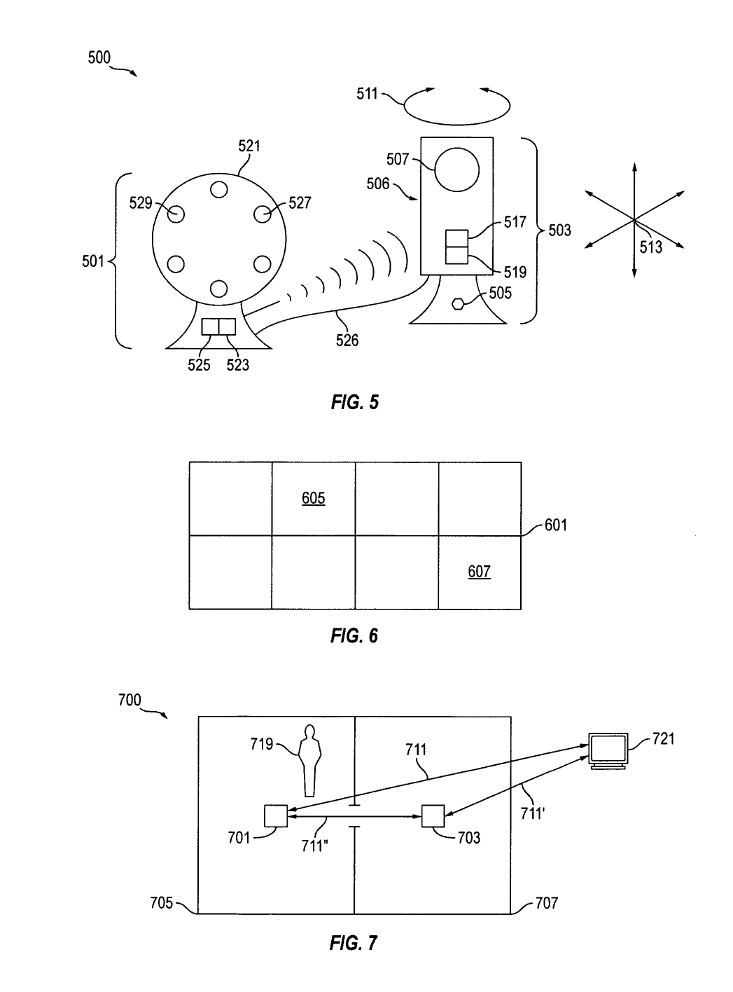

Now referring to FIG. 5, a video system 500 includes a sensor unit 501 that has any number or geometric shapes. For example the sensor unit 501 has a sensor portion 521 that is sphere, a cylinder, a dodecahedron or any other shape. The sensor portion 521 that includes an array of sensors 527 and 529 that project, generate or sense a two-dimensional or three-dimensional sensing field or sensing grid that emulates outward from the sensor unit 501. The sensors are CCD (charge coupled device) and CMOS (complementary metal oxide semiconductor) sensors, infrared sensors, or any other type of sensors and combinations of sensors. The sensor unit 501 also includes a processor unit 525 with memory that computes and stores location data within the sensing field or sensing grid based on which of the sensors within the array of sensors 527 and 529 are activated by a target as the target moves through the two-dimensional or three-dimensional sensing field or sensing grid. The sensor unit 501 also includes a wireless transmitter 523 or a chord 526 for transmitting the location data, location signals or version thereof to a video capturing unit 503. The sensor unit 501 moves, such as described above with reference to the video robot 102 (FIG. 1), or remains stationary.

The system 500 also includes a video capturing unit 503 with a housing 506, a camera unit 507 and a servo-motor 505, a processor unit (computer) 519 with memory and a receiver 517, such as described above. In operation, the sensing unit 501 transmits location data, location signals or version thereof to the video capturing unit 503 via the transmitter 523 or chord 526. The receiver 517 receives the location data, location signals or version thereof and communicates the location data or location signals, or a version thereof, to the processor unit 519. The processor unit 519 instructs the servo-motor 505 to move a field of view of the camera unit 507 in any number of directions, represented by the arrows 511 and 513, such that the target remains within the field of view of the camera unit 507 as the target moves through the two-dimensional or three-dimensional sensing field or sensing grid. In accordance with the embodiments of the invention any portion of the software to operated the video capturing unit 503 is supported or hosted by the processor unit 525 of the sensing unit 501 or the processing unit 519 of the video capturing unit 503.

Also as described above, the housing 506 of the video capturing unit 503 is moved by the servo-motor 505, the camera 507 is moved by the servo-motor 505 or a lens of the camera 507 is moved by the servo-motor 505. In any case, the field of view of the video capturing unit 503 adjusts to remain on and/or stay in focus with the target. It also should be noted that the video system 500 of the present invention can include auto-focus features and auto calibration features the allows the video system 500 to run an initial set-up mode to calibrate starting locations of the sensor unit 501, the video capturing unit 503 and the target that is being videoed. The video data captured by the video capturing unit 503 is live-streamed to or between remote users, pushed from a video capturing device to one or more remote or local video screens or televisions, mirrored from a video capturing device to one or more remote or local video screens or televisions, recorded and stored in a remote memory device or the memory of the processor unit 525 or the memory of the processing unit 519.

Now referring to FIG. 6, in accordance with the embodiments of the invention any one of the video systems described above includes a continuous larger area sensor 601. The large area sensor 601 has sensing quadrants or cells 605 and 607. Depending on which of the quadrants or cells 605 and 607 are most activated by a target, the video system adjusts a video capturing device 101 (FIG. 1) or video capturing unit 501 (FIG. 5) to keep the target within the field of view of the video capturing device or video capturing unit, such as described above.

FIG. 7 shows a system 700 of the present invention that includes plurality of video units 701 and 703. The video units 701 and 703 include a sensor unit and a video capturing unit, such as described in detail with reference to FIGS. 1 and 5. In operation the video units 701 and 703 communicate with a video display 721, such as a computer screen or televison screen and as indicated by the arrows 711 and 711′ in order to display representations of video data being captured by the video units 701 and 703. The video units 701 and 703 sense locations of a target or person 719 as the target or person 719 moves between rooms 705 and 707 and video capturing is handed off between the video units 701 and 703 as indicated by the arrow 711″, such that the video unit 701 and/or 703 that is in the best location to capture video of the target controls steaming, pushing or mirroring of representations of the video data displayed video display 721. Again, the location of the target or person 719 can be determined or estimate using a projected sensor area, such as described with reference to FIG. 6, a sensor array such as described with reference to FIG. 5, a transmitting sensor, such as decided with reference to FIGS. 1-3 and/or pattern recognition software operating from the video units 701 and 703.

For example, the video capturing units 701 and 703 use a continuous auto focus feature and/or image recognition software to lock onto a target and the video capturing units 701 and 703 include a mechanism for moving itself, a camera or a portion thereof to keep the target in the field of view of video capturing units 710 and 703. In operation, the video capturing units 701 and 703 take an initial image and based on an analysis of the initial image, a processor unit coupled to video capturing units 701 and 703 then determines a set of identifiers. The processor unit in combination with a sensor (which can be the imaging sensor of the camera) is then used these identifiers to move the field of view of the video capturing units 701 and 703 to follow the target as the target moves through a space or between the rooms 705 and 707. Alternatively, or in addition to computing identifiers and using identifiers to follow the target, the processor unit of the video capturing units 701 and 707 continuously samples portions of the video data stream and based on comparisons of the samples, adjusts the field of view such that target stays within the field of view of the video capturing units 701 and 703 as the target move through the space or between the rooms 705 and 707.

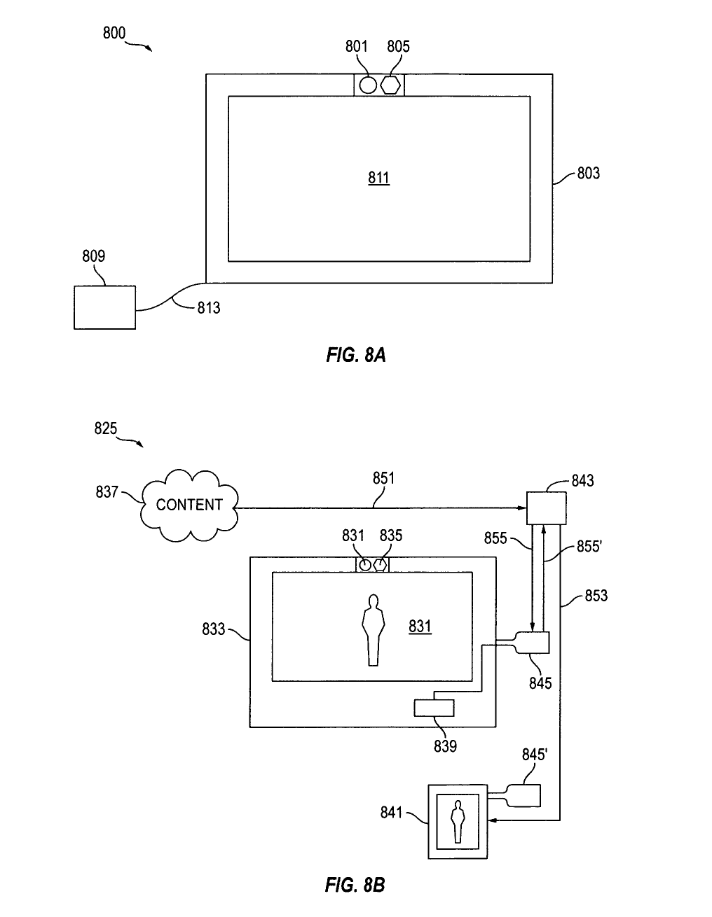

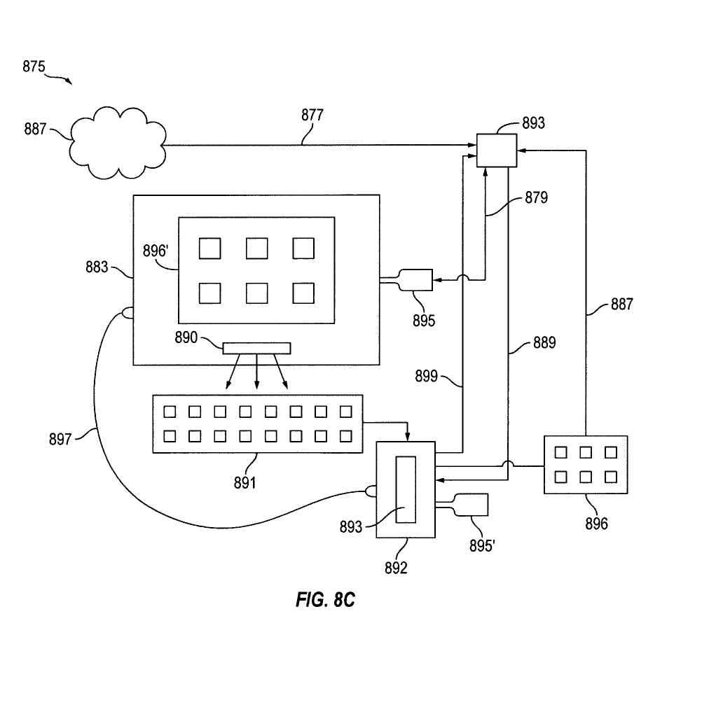

FIG. 8A shows video system 800 with a video display device or a televison 803 having a camera 801 and a sensor 805 for tracking a target, capturing video data of a target, receptively, and displaying representations of the video data on a screen 811. In accordance with this embodiment of the invention, the sensor 805 alone or in combination with a transmitting sensor (not shown), such as describe with respect to FIGS. 1-3, locates the target and communicates locations of the target to the camera through a micro-processor with software. The micro-processor then adjusts a field of view of the camera 801 through, for example, a micro-controller to position and re-position the camera 801, or portion thereof, such that the target remains in a field of view of the camera 801 as the target moves through a space around the video system 800. The video system 800 also preferably includes a wireless transmitter and receiver 809 that is in communication with the video display device or a televison 803 through, for example, a chord 813, and is capable of communicating with other local and/or remote video display devices to stream, push and/or mirror representations of the video data captured by the camera 801 or displayed on the screen 811 of the video display device or a televison 803.

FIG. 8B shows a view of a system 825 that includes a smart video screen, display device or televison 833, hereafter display, for mirroring and displaying a representation of the video data on a screen 831 that is pushed from a smart phone, a tablet, a computer or other wireless device (hereafter, smart device) over the internet, intranet or a local area network (hereafter network), represented by the arrows 851, 853 and 855. The display can include a television signal or cable television signal processing unit 839 for receiving network and cable broadcast. However, it will be clear to one skilled in the art that television capability is not required for the display 833 to operated as a smart display. The display 833 can include a video camera 831 and sensor 835 to operate as described above with reference to the video camera 801 and sensor 805 in FIG. 8A.

The system 825 includes a device 845 that is either integrated into (built-in to) the display 833 or plugs into the display 833 via, for example, a HDMI plug. The device 845 allows a user to mirror anything to the display that is being displayed or generated as graphics data on a the smart device 841. The device 845 wirelessly connects the display 833 to the network that, for example, includes a router 843 that is in communication with the cloud 837 and enables the display 833 to mirror data from the smart device 841 over the connected network onto the screen 831. In effect, the device 845 turns the display 833 into a avatar screen 831 for other smart devices.

The device 845 provides the display 833 with network address or name and/or an identification number (such as a phone number) that is broadcast over the network 851, 853 and 855. A user accesses the display 833 via one or more smart devices 841 remotely my calling the identification number and/or locally by accepting or selecting the network address or name that shows up as a network option on the one or more smart devices 841 corresponding to the display 833 being selected. The device 845 preferably includes a micro-processor, a radio transmitter/receiver and has blue-tooth functionality that is detected by one or more smart device 841 that also has blue-tooth functionality.

In operation, when the blue-tooth enabled smart device 841 is in proximity of the display 833, the display 833, via the device 845, detects the smart device 841 and automatically wakes up (is turned on) and mirrors content data from the smart device 845 to the display 833, so long as the user has previously selected the display 833. After, some period of time when the smart device 841 is no longer detected by the device 845, the display 833 goes in to hibernation mode. In addition, or alternatively, the smart device 841 runs an application that has an on and off select function.

The device 845 can be programmed with a negotiation protocol, software or firmware that determines which smart device 841 gets use of the display 833, when there are more than one smart devices 841 competing for use of the display 833, or the display 833 can be configured to split screen and mirror content data from all of the competing smart devices. Regardless, the device 845 lets a user mirror what is being displayed on his or her smart device 841 locally and preferably remotely.

The system 825, as shown can be used for mirroring any content data including, but not limited to video data, graphical data and document or word processing data created or captured from features or programs running on the smart device 841. Once content data is captured or created from the smart device 841, the user can preferably save the content data to memory of the smart device 841 and/or to a cloud-based 837 content data storage server using save features on the smart device 841, where the content data is stored for later access. Also, content data captured or created by the display 833, for example, by the video camera 831, can be mirrored to the smart device 841 and stored at the smart device 841 or in the cloud 837, as described. The system 825 with the device 845, as described above, could further enhance content data creation and manipulation by using relatively inexpensive displays to emulate data created and/or applications running smart devices and further can make processing content data from these smaller smart devices more feasible.

FIG. 8C shows a system 875 with a screen, monitor, display device or a televison 833, hereafter smart screen or smart monitor, for mirroring and displaying a representation 896′ of the content data 896 pushed from a computing device 892, such as a smart phone, over a network as indicated by the arrows, 887, 899 and 879. The system 875 also include a periphery tool 891, such as a keyboard an or mouse, for manipulating the content data 896. In an alternative embodiment of the invention, the computing device 893 is connected to the smart screen or smart monitor 883 via a cable 897, such as an HDMI cable, for transmitting the representation 896′ of the content data 896 to the smart screen or smart monitor 883. The periphery tool 891 can be a projection tool that is projected from a light source 890 on the smart screen or smart monitor 883. The light source includes location sensors for sensing locations or a users fingers or placement of a data manipulation object, such as a stylus or pen (not shown). The periphery tool 891 is synchronized or connected to the computing device 892 via blue tooth, wirelessly over the network or by a cable (not shown). In yet further embodiments of the invention, the smart screen or smart monitor 883 has a touch screen for manipulating the content data 896 through touching locations on the representation 896′ of the content data 896 pushed from a computing device 892 to the smart screen or smart monitor 883.

In accordance with the embodiments the invention the networking device 895 is either integrated into (built-in to) the smart screen or smart monitor 883 or plugs into the smart screen or smart monitor 883, for example, by a HDMI plug. The networking device 895 allows a user to mirror any content data including, but not limited to, word documents, spread sheets, graphics, videos and/or movies that is being generated on, displayed on or streamed to the computing device 892. The networking device 895 preferably includes a video card, micro-processor with memory and transponder that wirelessly connects the smart screen or smart monitor 883 to the interne 887, intranet or local area network router 893 (hereafter network) and turns the smart screen 883 into an avatar screen or monitor for other networked computing devices, such as the computing device 892, or video capturing devices, such as described above. The system 875 can also included a second networking device 895′ that creates a wi-fi hot-spot for the computing device 892 to be able to communicate with the smart screen or smart monitor 883 via a cellular network (not shown). Alternatively, content data from the smart screen or smart monitor 883 can be pushed to or mirrored on the computing device via the second networking device 895′.

In accordance with the embodiments of the invention, the networking device 895 provides the smart screen or smart monitor 883 with network address or name and/or an identification number (such as a phone number) that is broadcast over the network. A user accesses the smart screen or smart monitor 883 via one or more computing devices, such as the computing device 892, remotely my calling the identification number and/or locally by accepting or selecting the network address or name that shows up as a network option on the one or more computing devices that corresponds to the smart screen being selected. The networking device preferably has blue-tooth functionality that is detected by the computing device 892 that also has blue-tooth functionality. When the blue-tooth enabled computing device 892 is in proximity of the smart screen or smart monitor 883, the smart screen or smart monitor 883 detects the computing device and automatically wakes up (turns on) and mirrors the content data 896 from the computing device 892 to the smart screen or smart monitor 883, so long as the user has previously selected the smart screen or smart monitor 883 through, for example, a network option interface. After, some period of time when the computing device is no longer detected by the device, the smart screen or smart monitor 883 goes in to hibernation mode or shuts off. In addition, or alternatively to the location detection on and off feature, the computing device has an on and off select function to turnon and off the smart screen or smart monitor 883.

The networking device 895 can include a negotiation protocol that ruins on the micro-processor and that determines which computing device gets use of the smart screen or smart monitor 883 when there are more than one computing devices competing for use of the smart screen or smart monitor 883. Alternatively, firmware running on the micro-process or can be configured split-screen and mirror data from all of the competing smart devices. Regardless, the networking device 895 lets a user mirror content data from his or her computing device locally and preferably remotely. When the user is done manipulating the content data, the content data can be saved and stored locally on the computing device 892, remotely in the cloud 887 on a remote server or both.

The system described above device further enhance applications of content data and video data by using relatively in expensive smart screens or smart monitors to emulate screens of more expense computing devices and further could make data processing from smaller computing devices, such as smart phones, more feasible.

In further embodiments of the invention the a periphery tool is the computing device 892, whereby a control application that mimics a keyboard or a mouse is running on the computing device 892 to manipulate content data originating from invisible application or program running on the computing device all while being displayed on the networked smart screen or smart monitor 883. Manipulating content data on a computing device using an overlaying control program while mirroring a representation of the content data being manipulated on a networked smart screen or smart monitor is referred to as ghosting.

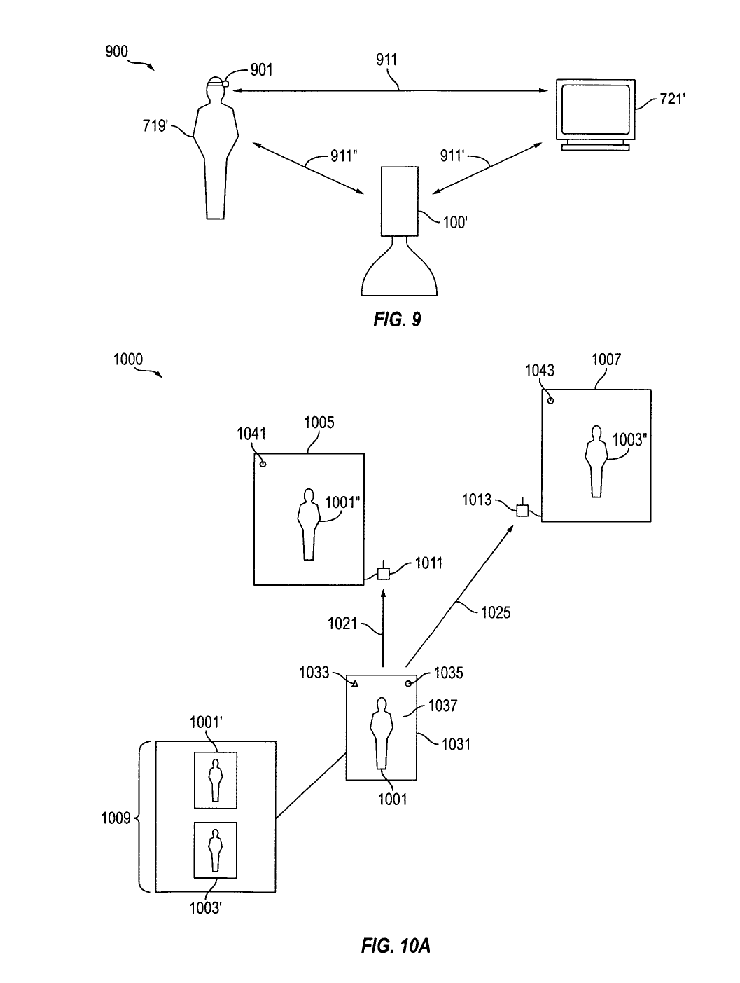

FIG. 9 shows a video system 900 with a head mounted camera 901, a video robot 100′ and a display unit 721′, in accordance with the embodiments of the invention. In operation a person 719′ wears the head mounted camera 901 and the head mounted camera 901 captures video data as the person 719′ moves through a space around the video system 900. The video data that is captured by the head mounted video camera 901 is transmitted to the display unit 721′ and/or the video robot 100′ as indicated by the arrows 911, 911′ and 911″ using any suitable means including, but not limited to, Wi-Fi to generate or display representations of the video data on the respective screens of the display unit 721′ and video robot 100′. The video robot 100′ includes a video capturing unit and a sensor unit, as described in detail with reference to FIGS. 1-3. The video robot 100′ tracks locations of the head mounted camera 901 and/or the person 719′ and captures dynamic video data of the person 719′ as the person 719′ move through the space around the video system 900. The video robot 100′ is also in communication with the display unit 721′ using any suitable means including, but not limited to, Wi-Fi, to generate or display representations of the video data captured by the video robot 100′ on the screen of the display unit 721′. The video data captured by the video robot 100′ can also be displayed on the screen of the video robot 100′. The video data, or a representation thereof, is streamed from the head mounted camera 901 to the display unit 721′ and/or the video robot 100′ and the video data, or a representation thereof, is pushed or mirrored between the video robot 100′ and the video display unit 721′.

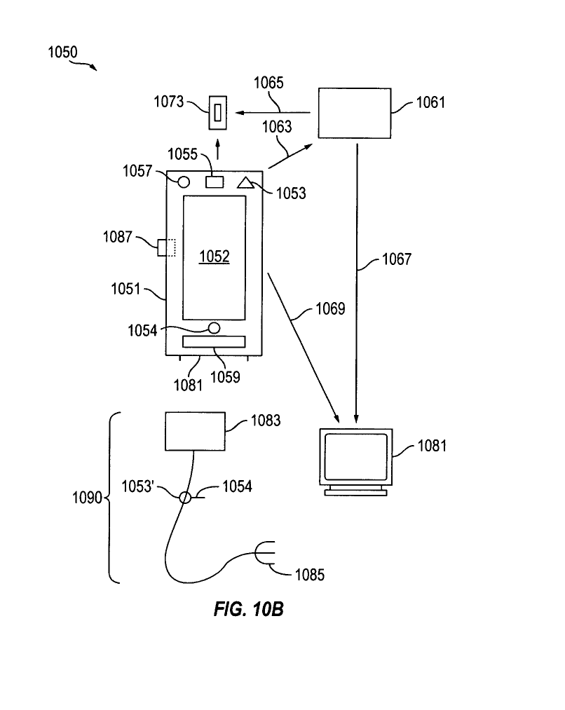

FIG. 10A shows a representation of a video system 1000 that includes a video capturing device 1031. The video capturing device 1031 is able to capture local video data and stream, push and/or mirror the video data to one or more selected video screens or televisions 1005 and 1007. The local video data is streamed, pushed and/or mirrored to the one or more selected video screens or televisions 1005 and 1007 through one or more wireless receivers 1011 and 1013, represented by the arrows 1021 and 1025. The one or more video screens or televisions 1005 and 1007 then display representations 1001″ and 1003″ of the video data.

In accordance with this embodiment, the video capturing device 1031 includes a wireless transmitter/receiver 1033 and a camera 1035 for capturing the local video data and/or receiving video data transmitted for one or more video capturing devices at remote locations (not shown). Representations of video data 1001 of the video data captured and/or received by the video capturing device 1031 can also be displayed on a screen of the video capturing device 1031 and the images displayed on the one or more video screens 1005 and 1007 can be mirrored images or partial image representations of the video data displayed 1001 on the screen of the video capturing device 1031.

Preferably, the video capturing device 1031 includes a user interface 1009 that is accessible from the screen of video capturing device 1031 or portion thereof, such that a user can select which of one or more video screens or televisions 1005 and 1007, displays images 1001′ and 1003′ of the video data being captured or received by the video capturing device 1031. In further embodiments of the invention the one or more video screens or televisions 1005 and 1007 are equipped with a sensor or sensor technology 1041 and 1043, for example, image recognition technology, such that the sensor or sensor technology 1041 and 1043 senses locations of a the user and/or the video capturing device 1031 and displays representations of the video data captured and/or received by the video capturing device 1031 on the one or more video screens or televisions 1005 and 1007 corresponding to near by locations of the user and/or video capturing device 1031.

FIG. 10B shows a representation of a video system 1050 that include a video capturing device 1051. The video capturing device 1051 is, for example, a smart phone that includes a motion sensor 1053 and a camera 1057. However, for this application it will be clear to one skilled in the art that the motion sensor 1053 is not required to execute the automatic video data or picture capturing that is described below. The video capturing device 1051 also includes a transducer 1055 for making and receiving data transmissions and a processing unit 1059 (micro-processor and memory device) for running software and applications and for storing communications data. In accordance with the embodiments of the invention, the video capturing device 1051 includes auto-video or auto-picture software. In operation, the video capturing device 1051 is instructed to be initialized, be activated, be turned on, or “be woken up” when motion is detected by the motion sensor 1053 or alternatively is instructed to be initialized, be activated, be turned on, or “be woken up” by actuating a manual switch 1054. When the video capturing device 1051 is initialized, activated, turned on, or “woken up” by the motion sensor 1053 detecting motion or by actuating the manual switch 1054, the auto-video or auto-picture software running on the processing unit 1059 instructs the camera 1057 to collect video data and/or take a picture. The video data or picture is preferably automatically streamed or sent to a remote location via a service provider data network as indicated by the arrow 1063 where it is stored on server 1061 and/or is sent to a remote computer 1081 through a wireless connection or a local area network, as indicated by the arrow 1069.

Once the video data streamed to, or the picture is sent to the sever 1061 or remote computer 1081, the video data and/or the picture is stored and a representation of the video data and/or the picture can be viewed on a monitor. Where the video data or picture is sent to the server 1061, the video data and/or picture can be accessed through the remote computer 1071,as indicated by the arrow 1067 or any other internet enabled device 1073, such as another smart phone, as indicated by the arrow 1065.

In accordance with the embodiments of the invention the auto-video or auto-picture software is configured to automatically send the video data and/or picture to a user's e-mail account or as an attachment data file to the other smart phone 1073. A person can the view a representation of the video data and/or picture and decide if the representation of the video data and/or picture constitutes an image of an authorized user. If the representation of the video data and/or picture is not of an authorized user, the person instructs the video capturing device 1051 to be locked, decommissioned or shut off, such that service over a cellular network is no longer available and/or files and data stored on the video capturing device can not be accessed.

Still referring to FIG. B in further embodiments of the invention the video system 1050 includes an internet enabled secured digital storage card 1087 that stores and/or automatically sends the video data and/or picture to a user's e-mail account or as an attachment data file to the other smart phone 1073, such as described above. Further, the video system 1050 can include a charger unit 1090 that includes an adapter that engages or mates with a matched adapter 1081 on the video capturing device 1051. The charging unit has a plug 1085 that plugs into a wall outlet to charge and/or power the video capturing device 1051, when the adapter 1083 and matched adapter 1081 are engaged or mated. The charger unit also includes a motion sensor that is inline between the adapter 1083 and plug 1085. In operation the motion sensor 1053′ acts as a switch that is closed when motion is sensed, thus causing the video capturing device 1051 be initialized, be activated, be turned on, or “be woken up” and automatically collect video data or take a picture via the camera 1057, such as described in detail above. The charger unit 1090 can include a by-pass switch 1054 that closes the electrical connection between the adapter 1083 and the plug 1085, such that the charger can used in a continuous charging mode. Alternatively, the motion sensor 1053′ provides a pulsed current when motion is detected. The pulsed current is recognized by the video capturing unit 1051 which causes the video capturing unit 1051 to be initialized, be activated, be turned on, or “be woken up” and thereby automatically collect video data or take a picture via the camera 1057, such as described in detail above.

In yet further embodiments of the invention, the video capturing device 1051 is programed with auto-answering software. In operation the video capturing device 1051 is “called” using a registered number or code by the smart phone 1073 or other internet enabled device and is thereby initialized, activated, turned on, or “ woken up” and instructed to automatically collect video data and/or take a picture via the camera 1057. In this mode, the video data, or representation thereof, can be live-streamed to the smart phone 1073 or other internet enabled device.

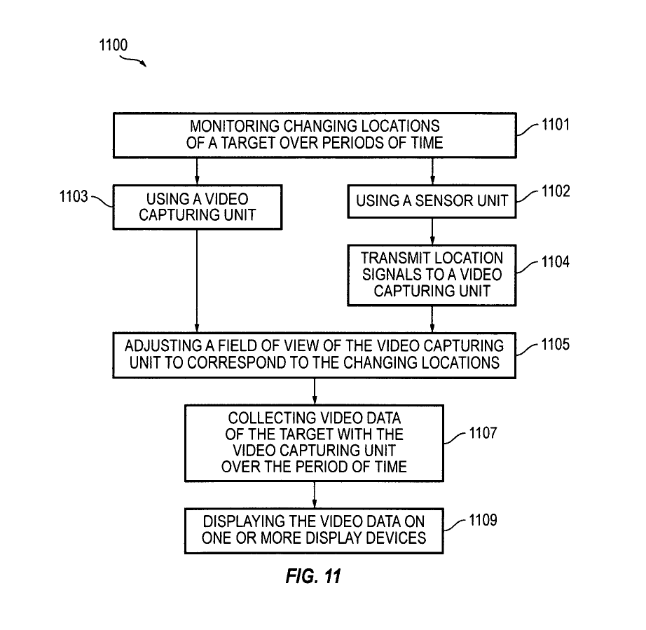

FIG. 11 shows a block flow diagram 1100 of the steps for capturing and displaying representations of video data corresponding to dynamic or changing locations of a target as the target moves through a space, in accordance with the method of the invention. In accordance with the method of the invention in the step 1101 locations of a target are monitored over a period of time. In the step 1103 the locations of the target are monitored directly from a video capturing unit using a sensor unit or alternatively the locations of the target are monitored using a sensor unit in combination with a transmitting sensor, such as described with reference to FIGS. 1-5 on or near the target in the step 1102. Locations of the target are communicated to or transmitted to the video capturing unit using a micro-processor programmed with software in the step 1104. Regardless of how the locations of the target are monitored, in the step 1105 a field of view of the video capturing unit is adjusted using a camera that is coupled to a micro-motor or micro-controller in order to correspond to the changing locations of the target over the period of time, such as described with reference to FIGS. 1-3 and 5. While adjusting the field of view of the video capturing unit in the step 1105, simultaneously in the step 1107 the video capturing unit collects, captures and/or records video data of the target over the period of time. While the video data is colleted, captured or recorded in the step 1107, in the step 1009 a representation of the video data is displayed on one or more display devices, such as described with reference to FIGS. 7-10.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A system comprising
a) a viewing device with a screen; and
b) with a networking device for connecting the viewing device to a network;
c) a computing device for manipulating content data; and
d) an application for displaying a representation of the content data on the screen of the viewing device from the computing device, wherein the networking device broadcasts an address to the computing device over the network.

2. The system of claim 1, wherein the networking device includes a video card, micro-processor with memory and transponder that wirelessly connects the viewing device to the network.

3. The system of claim 1, wherein the networking device electrically couples to the viewing device through an HDMI plug.

4. The system of claim 1, wherein the computing device is a smart phone.

5. The system of claim 1, wherein the computing device includes a video camera.

6. The system of claim 5, further comprising a location sensing mechanism for sensing locations of a target within a space and a mechanism for automatically selecting a field of view of the video camera to correspond to the locations of the target.

7. The system of claim 1, further comprising a user interface for selecting the viewing device from the computing device.

8. The system of claim 1, further comprising a user interface for selecting video display units that display representations of the video data.

9. The system of claim 1, wherein the networking device automatically senses the presence of the computing device when the computing device is within the network.

10. The system of claim 9, wherein the networking device includes a blue-tooth sensor automatically senses the presence of the computing device when the computing device is within the network.

11. The system of claim 10, wherein the video capturing unit includes smart phone.

12. A system comprising
a) a viewing device with a screen;
b) with a networking device for connecting the viewing device to a network;
c) a computing device for manipulating content data; and
d) an application for displaying a representation of the content data on the screen of the viewing device, wherein the networking device automatically senses the presence of the computing device when the computing device is within the network.

13. A system comprising
a) a video capturing unit for capturing video data;
b) a location sensing mechanism for sensing locations of a target within a space;
c) a mechanism for automatically selecting a field of view of the video capturing unit to correspond to the locations of the target as the subject moves through the locations in the space while the video capturing unit is capturing the video data; and
d) a viewing device with a screen for displaying a representation of the video data transmitted to the viewing device over a wireless network from the video capturing unit.
